(19) United States
(12) Patent Application Publication
(10) Pub. No.: US 2026/0162307 A1
(43) Pub. Date: Jun. 11, 2026

(54) CALIBRATION METHOD AND ANALYTICAL METHOD OF DETECTING AN ANALYTE IN A BODY FLUID

(71) Applicant: Roche Diabetes Care GmbH, Mannheim (DE)

(72) Inventors: Thomas Kuensting, Weinheim (DE); Bernhard Limburg, Soergenloch (DE); Max Berg, Mannheim (DE)

(21) Appl. No.: 19/538,449

(22) Filed: Feb. 12, 2026

Related U.S. Application Data
(63) Continuation of application No. PCT/EP2024/072407, filed on Aug. 8, 2024.

(30) Foreign Application Priority Data
Aug. 14, 2023 (EP) 23 191 338.5

(51) Int. Cl. G06T 7/80; G01J 1/42; G01N 21/77; G01N 21/78; H04N 23/56; H04N 23/71; H04N 23/74

(52) U.S. Cl. CPC G06T 7/80; G01J 1/4204; G01N 21/78; H04N 23/56; H04N 23/71; H04N 23/74; G01N 2021/7759; G01N 2201/127; G06T 2207/30004

(57) ABSTRACT

A calibration method for use in an analytical method of detecting an analyte in a sample of a body fluid. In the inventive method, a set of lighting conditions is provided and a calibration set including calibration functions for each of the lighting conditions is determined. Each calibration function provides a relationship between optical information derived from an image captured with a camera of a test field of an optical test element and a concentration of the analyte in a sample applied to the test field. A light sensor value is obtained by an ambient light sensor for each of the lighting conditions of the set of lighting conditions, and light sensor values are assigned to the respective calibration functions of the calibration set. Further disclosed is a computer-implemented analytical method and a mobile device, a computer program and a computer-readable storage medium for performing the analytical method.

### RELATED APPLICATIONS

This application is a continuation of International Patent Application No. PCT/EP2024/072407, filed Aug. 8, 2024, which claims priority to EP 23 191 338.5, filed Aug. 14, 2023, both of which are hereby incorporated herein by reference.

### BACKGROUND

This disclosure refers to a calibration method for use in an analytical method of detecting at least one analyte in a sample of a body fluid by using a mobile device and to a computer-implemented analytical method of detecting at least one analyte in a sample of a body fluid by using a mobile device. This disclosure further refers to a mobile device, a computer program and a computer-readable storage medium for performing the analytical method. The methods and devices may specifically be used in medical diagnostics in order to quantitatively or qualitatively detect one or more properties of a sample of a body fluid. As an example, the methods and devices may be used for qualitatively detecting the presence of the SARS-CoV-2 coronavirus in the sample of the body fluid or, alternatively, for quantitatively detecting an analyte, such as blood glucose, in the sample of the body fluid. Other fields of application of this disclosure, however, are also feasible.

In the field of medical diagnostics, devices and methods are known which make use of test elements comprising one or more test chemicals, which, in presence of an analyte to be detected, are capable of performing one or more optically detection reactions. The optically detection reactions may be evaluated using dedicated optical readout technologies, specifically making use of optical detection means, e.g., cameras or optical sensors or the like. Generally, these optical readout technologies are susceptible to ambient light and, thus, comprise implementation of ambient light checks. Specifically in the field of home medical diagnostics, where specifically designed medical devices are not available and/or inconvenient, optical readout technologies are known which make use of generic mobile devices, such as smartphones, e.g., smartphone-camera based readout technologies. These readout technologies generally only implement ambient light checks comprising simple checks for the pure amount of ambient light present during the measurement. For example, if the amount of ambient light is found to be too high for performing the optical readout, e.g., in case a mobile device inherent light source, such as a smartphone flashlight, cannot dominate the scene, the measurement is prevented and no measurement can be carried out at this location under these ambient lighting conditions.

U.S. Pat. No. 11,079,277 B2 discloses a spectral imaging apparatus and a method in which spectra are obtained from the captured photographs for composition analysis. In addition, the environment can be protected by using the spectral imaging device and method. Furthermore, a true color photo can also be obtained.

U.S. Publication No. 2022/0067544 A1 describes acquiring an image or a spectrum of a surface by a computing device, which may be included in a mobile device in some examples. The computing device may extract a measured spectrum from the image and generate a corrected spectrum of the surface. In some examples, the corrected spectrum may be generated to compensate for ambient light influence. The corrected spectrum may be analyzed to provide a result, such as a diagnosis or a product recommendation. In some examples, the result is based, at least in part, on a comparison of the corrected spectrum to reference spectra. In some examples, the result is based, at least in part, on an inference of a machine learning model.

U.S. Publication No. 2016/0113503 A1 discloses techniques for respiratory and metabolic monitoring in mobile devices, wearable computing, security, illumination, photography, and other applications using a phosphor-coated broadband white LED to produce broadband light, which may be transmitted along with ambient light to a target (e.g., ear, face, wrist, or the like). Some scattered light returning from a target may be passed through a spectral filter to produce multiple detector regions sensitive to a different waveband and/or wavelength range, and the detected light may be analyzed to determine a measure of a respiratory rate or effort. In the absence of LED light, ambient light may be sufficient illumination for analysis. The disclosed techniques may provide identifying features of type or status of a tissue target (e.g., respiratory rate, heart rate, heart rate variability, heart function, lung function, fat content, hydration status, confirmation of living tissue, and the like).

WO 2018/156869 A1 discloses a system and method for detecting mobile device fault conditions, including detecting fault conditions by software operating on the mobile device. The system and method uses a neural network to detect, from an image of the device, that the mobile device has a defect, for instance a cracked or scratched screen. The system and method also report the defect status of the device, working or not, so that appropriate action may be taken by a third party.

U.S. Pat. No. 10,733,942 B2 describes electronic devices with displays and ambient light sensors. An electronic device modifies the color of images to be displayed based on measured ambient light color. The modification is performed in a perceptually uniform color space and includes a determination of a bleaching effect of reflected ambient light, and a determination of a color correction factor to be applied within the perceptually uniform color space, based on the determined bleaching effect. The modification may also include an application of a strength factor that mitigates out-of-gamut colors in color compensated images.

U.S. Pat. No. 11,537,215 B2 discloses an ambient light sensing device which receives at least one visible light image sensed by an image sensor. The ambient light sensing device includes an image sampling unit and an analyzing unit. The image sampling unit divides the visible light image into plural image blocks, extracts at least one sample data in each image block, and generates a comparison data according to a difference between the sample data extracted at different time points. The analyzing unit analyzes the comparison data and generates an output analysis signal accordingly.

U.S. Pat. No. 9,934,589 B2 describes a system and method for determining bilirubin levels in an individual based on skin coloration using a smartphone or other personal device and an attached ancillary apparatus. The device, such as a smartphone or tablet, is capable of storing and running software. The device is also coupled to both a camera and light source to obtain data regarding the skin's coloration. Software is installed on the device to control the light source and calculate bilirubin levels in the individual based on the input received from the camera. The ancillary apparatus is a mechanism surrounding the light source and camera that is placed on the skin of the individual when the system is in use. The ancillary apparatus thus creates a light tight seal between the skin, light source and camera, enabling the system to receive the most accurate data from the camera.

U.S. Publication No. 2022/0072532 A1 discloses a system that enables urine testing in a home environment. A user may apply a urine sample to a card containing multiple tests, and capture an image of the card using a phone; an analysis system executing on the phone or in the cloud may analyze the image and determine test results. The test card and analysis system may compensate for variability in lighting conditions and time of exposure to the urine sample, which are difficult to control in a home environment. The test card may contain fiducial markers of known colors; the analysis system may adjust colors in the captured image based on appearance of these markers. Color adjustments may also compensate for non-uniform lighting across the card. The card may also contain time indicators that change appearance over time after urine is applied, and the analysis system may use these indicators to calculate the time of exposure.

U.S. Publication No. 2015/0055134 A1 describes a method, system and computer program for analyzing a colorimetric assay that includes obtaining an image of the assay, optionally correcting for ambient lighting conditions in the image, converting the intensity data for at least one of the red channel, the green channel, or the blue channel to a first data point, recalling a predetermined standardized curve, comparing the first data point with the standardized curve, and identifying the value for the assay parameter from the standardized curve.

U.S. Publication No. 2016/0048739 A1 discloses a diagnostic system for biological samples. The diagnostic system includes a diagnostic instrument, and a portable electronic device. The diagnostic instrument has a reference color bar and a plurality of chemical test pads to receive a biological sample. The portable electronic device includes a digital camera to capture a digital image of the diagnostic instrument in uncontrolled lightning environments, a sensor to capture illuminance of a surface of the diagnostic instrument, a processor coupled to the digital camera and sensor to receive the digital image and the illuminance, and a storage device coupled to the processor. The storage device stores instructions for execution by the processor to process the digital image and the illuminance, to normalize colors of the plurality of chemical test pads and determine diagnostic test results in response to quantification of color changes in the chemical test pads.

Despite the advantages achieved by known methods and devices, several technical challenges remain. Specifically, if the ambient lighting conditions cannot be changed easily, such as outside where an additional light source cannot dominate the scene, the measurement may be hindered by the simple ambient light check only allowing the measurement in case ambient lighting conditions are found to be within a predetermined range. Furthermore, since the measurement generally uses several acquired images, it may happen that the measurement can be started as the ambient lighting conditions at a start are within the predetermined range, but not finished as the ambient lighting conditions at an end are outside the predetermined range.

### SUMMARY

This disclosure teaches methods and devices which at least partially address the above-mentioned technical challenges. Specifically, methods and devices are disclosed which improve ambient light checks for optical read-out of test elements to allow measurements even under unfavorable ambient lighting conditions.

As used in the following, the terms “have,” “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B,” “A comprises B” and “A includes B” may both refer to a situation in which, besides B, no other element is present in A (i.e., a situation in which A solely and exclusively consists of B) and to a situation in which, besides B, one or more further elements are present in entity A, such as element C, elements C and D or even further elements.

Further, it shall be noted that the terms “at least one,” “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once. It shall also be understood for purposes of this disclosure and appended claims that, regardless of whether the phrases “one or more” or “at least one” precede an element or feature appearing in this disclosure or claims, such element or feature shall not receive a singular interpretation unless it is made explicit herein. By way of non-limiting example, the terms “image,” “analyte,” “item of optical information,” and “light sensor value” to name just a few, should be interpreted wherever they appear in this disclosure and claims to mean “at least one” or “one or more” regardless of whether they are introduced with the expressions “at least one” or “one or more.” All other terms used herein should be similarly interpreted unless it is made explicit that a singular interpretation is intended.

Further, as used in the following, the terms “preferably,” “more preferably,” “particularly,” “more particularly,” “specifically,” “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

In a first aspect of this disclosure, a calibration method for use in an analytical method is disclosed. The analytical method is an analytical method of detecting at least one analyte in a sample of a body fluid by using a mobile device having at least one camera and at least one ambient light sensor.

The calibration method comprises the following method steps, which specifically may be performed in the given order. However, a different order may also be possible. It is further possible to perform one, more than one or even all of the method steps repeatedly. Further, it is possible to perform two or more of the method steps in a fashion overlapping in time and/or fully or partially simultaneously.

The calibration method comprises:
a. providing a set of lighting conditions; and
b. determining a calibration set, the calibration set comprising calibration functions for each of the lighting conditions of the set of lighting conditions, each calibration function providing a relationship between at least one item of optical information derived from at least one image captured with the camera from at least one part of at least one test field of an optical test element under the respective lighting condition and a concentration of the analyte in a sample applied to the test field.

The term “calibration method” as used herein is a broad term and is to be given its ordinary and customary meaning to a person of ordinary skill in the art and is not to be limited to a special or customized meaning. The term specifically may refer, without limitation, to a method of establishing, under specified conditions, one or more parameters and/or one or more relation linking one or more measurement values with one or more “true” or “real” values, e.g., one or more values provided by a calibration standard and/or one or more values obtained under standard conditions. The result of the calibration method may, thus, comprise one or more parameters and/or one or more relations which may be used for directly or indirectly transforming one or more measurement values into one or more results or values which are assumed to reflect a real state of a system or object from which the measurement values are gained.

The term “for use in an analytical method” as used herein is a broad term and is to be given its ordinary and customary meaning to a person of ordinary skill in the art and is not to be limited to a special or customized meaning. The term specifically may refer, without limitation, to the fact that the results of the calibration method are configured for being used in the analytical method.

The term “analytical method” as used herein is a broad term and is to be given its ordinary and customary meaning to a person of ordinary skill in the art and is not to be limited to a special or customized meaning. The term specifically may refer, without limitation, to a quantitative determination of the at least one property of the sample of the body fluid, such as at least one of a physical, a chemical and a biological property. The analytical method specifically may be an in vitro analytical method. The determination of the at least one property may specifically comprise quantitatively detecting at least one analyte in the sample of the body fluid. The result of the analytical method may comprise at least one item of information indicating a concentration of the at least one analyte of interest. The analyte may be or may comprise at least one arbitrary, dedicated and/or predetermined chemical or biological substance or species, such as at least one molecule or at least one chemical and/or biological compound. For example, the analyte may be or may comprise at least one specific virus and/or any parts thereof. The result of the analytical method may be or may comprise at least one item of information indicating the concentration of the virus or parts thereof in the sample of the body fluid. For example, the analyte may be a chemical compound which takes part in metabolism, such as one or more of glucose, lactate, cholesterol or triglycerides. For example, the analytical method may be a blood glucose measurement and, thus, the result of the analytical method may be a blood glucose concentration. Additionally or alternatively, the analytical method may relate to a method for detecting an RNA virus in a sample of body fluid. The method specifically may comprise the steps of releasing viral RNA from the sample, amplifying at least parts of the viral RNA comprised in said sample, and contacting the amplified viral RNA with at least one detecting reagent, such as at least one detecting reagent containing at least one nuclease, such as in lateral flow tests known in the art. As an example, the analytical method may comprise binding a viral antigen to an antibody, which may comprise a detectable label, such as a gold particle, a dye or the like. As another example, the analytical method may comprise performing a lateral flow test; appropriate methods are known in the art. Additionally or alternatively, other types of analytes or parameters may be determined, such as a pH value or the like.

The term “detecting an analyte in a sample” as used herein is a broad term and is to be given its ordinary and customary meaning to a person of ordinary skill in the art and is not to be limited to a special or customized meaning. The term specifically may refer, without limitation, to a quantitative determination of at least one analyte in an arbitrary sample. For example, the sample may comprise a body fluid, such as blood, interstitial fluid, urine, saliva or other types of body fluids. The result of the analytical method, as an example, may be a concentration of the analyte. Specifically, as an example, the analytical method may be a blood glucose measurement. The result of the analytical method may, as an example, be a blood glucose concentration. The detecting of the analyte in the sample of the body fluid may comprise determining a concentration of the analyte in the sample of the body fluid. In particular, an analytical measurement result value may be determined by the analytical method.

The term “in vitro” as used herein is a broad term and is to be given its ordinary and customary meaning to a person of ordinary skill in the art and is not to be limited to a special or customized meaning. The term specifically may refer, without limitation, to a method which uses components of an organism and which is at least partially performed isolated from usual biological surroundings of the components of the organism. For example, the in vitro analytical method may comprise using the sample of the body fluid isolated from a user or patient, specifically using the sample of the body fluid in at least one optical test element, as will be outlined in further detail below.

The term “sample of a body fluid” as used herein is a broad term and is to be given its ordinary and customary meaning to a person of ordinary skill in the art and is not to be limited to a special or customized meaning. The term specifically may refer, without limitation, to an arbitrary aliquot part or aliquant part of a biological fluid which directly is a body fluid or which is derived from a body fluid, such as by one or more pre-processing steps, e.g., by transferring a body fluid to at least one sampling fluid, by diluting a body fluid, by centrifugation a body fluid or the like. The body fluid may comprise one or more of saliva, blood, interstitial fluid, urine or other types of body fluids. The sample of the body fluid may be collected via at least one nasopharyngeal swab, at least one swab of the anterior nares or from saliva, such by applying a cotton swab to a surface of the anterior nares and/or the throat. The collected sample of body fluid may be transferred to at least sampling or reagent fluid by immersing the cotton swab in the sampling or reagent fluid. The sampling or reagent fluid may specifically comprise lysis reagents. Alternatively or additionally, the sample of the body fluid may be a droplet of a body fluid as gathered from the body of a person, such as a droplet of saliva and/or blood and/or interstitial fluid or the like. The sample of the body fluid may specifically comprise at least one preparation of the body fluid, such as a cell preparation of the body fluid, e.g., a stained cell preparation of the body fluid. The sample of body fluid may also be simply referred to as the sample or the test sample.

The term “mobile device” as used herein is a broad term and is to be given its ordinary and customary meaning to a person of ordinary skill in the art and is not to be limited to a special or customized meaning. The term specifically may refer, without limitation, to a mobile electronics device, more specifically to a mobile communication device, such as a cell phone and/or a smartphone. Additionally or alternatively, the mobile device may also refer to a notebook, a tablet computer or another type of portable computer having at least one camera. Thus, generally, the mobile devices may be selected from the group consisting of: a cell phone having at least one camera, specifically a smartphone; a portable computer having at least one camera, specifically at least one of a notebook and a tablet computer.

As outlined above, the mobile device is used both for the calibration method and for the analytical method. Thus, in step b. of the calibration method and/or in step i. of the analytical method, the camera of the mobile device may be used, as will be outlined in further detail below. Further operations of the calibration method and/or of the analytical method may be performed by other means than the mobile device. Thus, as an example, the determining of the calibration set, specifically of the relationship, may be performed by a processor distinct from the mobile device. Additionally or alternatively, however, these operations may also be performed with the mobile device itself. Further, in the calibration method and in the analytical method, one and the same mobile device may be used. Alternatively, however, different mobile devices may be used, such as mobile devices of the same or similar type. Thus, as an example, the calibration method may be performed with a prototypical mobile device representing a group of mobile devices with which the analytical method may then be performed, using the results of the calibration method.

The term “camera” as used herein is a broad term and is to be given its ordinary and customary meaning to a person of ordinary skill in the art and is not to be limited to a special or customized meaning. The term specifically may refer, without limitation, to a device having at least one imaging element configured for recording or capturing spatially resolved one-dimensional, two-dimensional or even three-dimensional optical data or information. As an example, the camera may comprise at least one camera chip, such as at least one CCD chip and/or at least one CMOS chip configured for recording images. As used herein, without limitation, the term “image” specifically may relate to data recorded by using the camera, such as a plurality of electronic readings from the imaging device, such as the pixels of the camera chip.

The camera, besides the at least one camera chip or imaging chip, may comprise further elements, such as one or more optical elements, e.g., one or more lenses. As an example, the camera may be a fix-focus camera, having at least one lens which is fixedly adjusted with respect to the camera. Alternatively, however, the camera may also comprise one or more variable lenses which may be adjusted, automatically or manually. This disclosure specifically shall be applicable to cameras as usually used in mobile applications, such as notebook computers, tablets or, specifically, cell phones such as smartphones. Thus, specifically, the camera may be part of the mobile device which, besides the at least one camera, comprises one or more data processing devices such as one or more data processors. Other cameras, however, are feasible.

The camera specifically may be a color camera. Thus, such as for each pixel, color information may be provided or generated, such as color values for three colors R, G, B. A larger number of color values is also feasible, such as four colors for each pixel, for example, R, G, G, B. Color cameras are generally known to the skilled person. Thus, as an example, each pixel of the camera chip may have three or more different color sensors, such as color recording pixels like one pixel for red (R), one pixel for green (G) and one pixel for blue (B). For each of the pixels, such as for R, G, B, values may be recorded by the pixels, such as digital values in the range of 0 to 255, depending on the intensity of the respective color. Instead of using color triples such as R, G, B, as an example, quadruples may be used, such as R, G, G, B or C, M, Y, K or the like. The color sensitivities of the pixels may be generated by color filters or by appropriate intrinsic sensitivities of the sensor elements used in the camera pixels. These techniques are generally known to the skilled person.

The term “ambient light sensor” as used herein is a broad term and is to be given its ordinary and customary meaning to a person of ordinary skill in the art and is not to be limited to a special or customized meaning. The term specifically may refer, without limitation, to a device having at least one element configured for generating at least one item of information, specifically at least one item of electrical information, on ambient light, to which the mobile device presently is exposed and/or under which the present measurement and/or imaging is performed. Specifically, the ambient light sensor may comprise at least one optical sensor, such as at least one semiconducting optical sensor. Additionally or alternatively, the ambient light sensor may comprise at least one further camera, such as a front camera of the mobile device. The ambient light sensor specifically may fully or partially be distinct from the camera, or may, specifically, be distinct from at least one portion of the camera used for capturing the images, such as in step b. of the calibration method and/or of step ii. of the analytical method.

The ambient light sensor of the mobile device may comprise at least one of: a color sensor of the mobile device; a further camera of the mobile device, specifically a further camera being disposed on a side of the mobile device opposing the side of the camera used for capturing the images in step b.

The mobile device may further comprise at least one processor. The term “processor” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. In particular, the processor may be configured for processing basic instructions that drive the computer or system. As an example, the processor may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. In particular, the processor may be a multi-core processor. Specifically, the processor may be or may comprise a central processing unit (CPU). Additionally or alternatively, the processor may be or may comprise a microprocessor, thus specifically the processor's elements may be contained in one single integrated circuitry (IC) chip. Additionally or alternatively, the processor may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processor specifically may be configured, such as by software programming, for performing one or more evaluation operations as will be outlined in further detail below.

The term “providing” as used herein is a broad term and is to be given its ordinary and customary meaning to a person of ordinary skill in the art and is not to be limited to a special or customized meaning. The term specifically may refer, without limitation, to at least one of retrieving, generating and selecting data to be provided. Thus, as an example, the set of lighting conditions, in step a. may be provided in a digital format, such as by providing, from a data storage device, from a user input or via at least one interface, a set of lighting conditions.

The term “lighting condition” as used herein is a broad term and is to be given its ordinary and customary meaning to a person of ordinary skill in the art and is not to be limited to a special or customized meaning. The term specifically may refer, without limitation, to at least one item of information characterizing an illumination or lighting of an object, a system or a scenery. The at least one item of information may, specifically, relate to at least one item of information selected from the group consisting of an intensity of illumination, a spectral composition of the illumination, a frequency of the illumination, a wavelength of the illumination, and a color temperature of the illumination. The item of information, as an example, may comprise one or more optical parameter values, wherein single values or parameter ranges may be given.

The term “set of lighting conditions” as used herein is a broad term and is to be given its ordinary and customary meaning to a person of ordinary skill in the art and is not to be limited to a special or customized meaning. The term specifically may refer, without limitation, to a plurality of lighting conditions, e.g., at least two lighting conditions, specifically to a plurality of different lighting conditions.

Each of the lighting conditions of the set of lighting conditions provided in step a. of the calibration method may, as an example, be characterized by a specific spectral composition and/or by an intensity distribution. Other parameters, however, may be used additionally or alternatively, for characterizing each set of lighting conditions. With the spectral compositions, for example, it may be feasible to assign specific light sensor values of the ambient light sensor to each lighting condition of the set of lighting conditions, so that, in reverse, it is feasible to deduce the given lighting conditions from the light sensor value.

The set of lighting conditions, as an example, may comprise different classes of lighting conditions. As an example, the lighting conditions may contain at least two, specifically at least three, classes of lighting conditions selected from the group consisting of: daylight, incandescent light, fluorescent light, halogen light, cool white LED illumination, warm white LED illumination, direct sun light, cloudy sky. Evidently, for each of these classes, a different spectral composition of the illumination is typically given. Thus, over the visible spectral range, daylight typically has a rather broad and even spectral composition, whereas incandescent light typically has an increasing intensity towards the infrared end of the spectrum. Fluorescent light typically has a plurality of single spectral peaks. Halogen light typically has a rather broad spectral peak, e.g., in the yellow or red spectral range. Thus, generally, the spectral composition of the different classes of lighting conditions as mentioned above, is rather different, and by classifying, by using the ambient light sensor, actual illumination, a specific correction may be performed. Thus, specifically, the analytical method may comprise classifying the actual lighting condition by using the light sensor value of the ambient light sensor obtained in step ii., thereby determining the class of lighting conditions presently given during the performing of the analytical method, and, in accordance with the class of lighting conditions, selecting the calibration function in step iii.

The term “calibration set” as used herein is a broad term and is to be given its ordinary and customary meaning to a person of ordinary skill in the art and is not to be limited to a special or customized meaning. The term specifically may refer, without limitation, to an arbitrary collection of one or more parameters and/or one or more relations linking the one or more measurement values with the one or more “true” or “real” values. The calibration set may specifically be or may comprise at least one classified collection of parameters and/or relations associating the parameters and/or relations with at least one of the lighting conditions. For example, the calibration set may comprise, for each lighting conditions of the set of lighting conditions, at least one parameter and/or relations, specifically exactly one parameter and/or relation, for linking the one or more measurement values with the one or more “true” or “real” values. Consequently, the term “determining a calibration set” as used herein, may refer, without limitation, to a process of generating the collection of parameters and/or relations of the calibration set, specifically in a classified fashion, as described above. Step b. may specifically comprise generating the calibration set as a set of computer-readable data.

The term “calibration function” as used herein is a broad term and is to be given its ordinary and customary meaning to a person of ordinary skill in the art and is not to be limited to a special or customized meaning. The term specifically may refer, without limitation, to one or more parameters and/or one or more relations linking the one or more measurement values with the one or more “true” or “real” values, as described above. The calibration function may specifically comprise at least one correlation and/or assignment, e.g., at least one mathematical operation, such as a multiplication with at least one factor or another type of mathematical operation, linking the item of optical information derived from the image captured with the camera from the at least one part of the test field of the optical test element with the concentration of the analyte in the sample. The calibration function may be specific for each lighting condition. The calibration function may be configured for linking the item of optical information obtained under the respective lighting condition with the “true” or “real” concentration of the analyte in the sample. The calibration function may be a continuous or a discontinuous function, a curve, a lookup table, an operator or any other means describing the link between the item of optical information and the concentration of the analyte in the sample. The calibration function may be a one-dimensional, two-dimensional or a multidimensional calibration function. The calibration function may specifically be a scalar calibration function. For example, the calibration function may be a function linking two or three color values of the item of optical information to the concentration of the analyte in the sample. For example, the calibration function may comprise a function f(x, y)=c, wherein x and y denote two color values of the item of optical information and c denotes the concentration of the analyte in the sample. In other words, the calibration function may take the item of optical information as input and may output the concentration of the analyte in the sample.

The term “relationship” as used herein is a broad term and is to be given its ordinary and customary meaning to a person of ordinary skill in the art and is not to be limited to a special or customized meaning. The term specifically may refer, without limitation, to the link of the one or more measurement values with the one or more “true” or “real” values, as described above. Specifically, the relationship may assign the item of optical information derived from the image captured with the camera from the at least one part of the test field of the optical test element under the respective lighting condition to the “true” or “real” concentration of the analyte in the sample.

The term “item of optical information” as used herein is a broad term and is to be given its ordinary and customary meaning to a person of ordinary skill in the art and is not to be limited to a special or customized meaning. The term specifically may refer, without limitation, to an item of information, e.g., on at least one object and/or radiation emitted by at least one object, characterizing at least one optical property of the object, more specifically at least one item of information characterizing, e.g., qualifying and/or quantifying, at least one of a transmission, an absorption, a reflection and an emission of the object. The item of optical information may be optically determinable, such as from at least one image captured with the camera of the mobile device.

The item of optical information may comprise at least one of: a remission value; a color information, specifically a color information in one or more of a RGB color space, a L*a*b color space, a XYZ color space; a part of a color information, specifically one or more of a red color value and/or a green color value, more specifically a combination of a red color value and a green color value.

The item of optical information may specifically comprise at least one color value in a color space. The term “color space” as used herein is a broad term and is to be given its ordinary and customary meaning to a person of ordinary skill in the art and is not to be limited to a special or customized meaning. The term specifically may refer, without limitation, to a coordinate system by which a color of an object, such as a color of a test field or a color of an image recorded by a camera, may be characterized, such as mathematically or physically. Various color coordinate systems are generally known to the skilled person, such as color coordinate systems defined by the CIE (Commission internationale de l'éclairage). Color coordinate systems other than those defined by the CIE are also feasible. The color coordinates, in their entirety, may span or define the color space, such as by defining three or four basis vectors. Thus, when the camera captures an image of an object, a value for each color coordinate is generated by the camera for each pixel. As an example, the camera chip may contain color sensors recording values for each color, such as triples like RGB (Red Green Blue) and L*a*b or quadruples like CMYK (cyan, magenta, yellow, key), wherein the values are dependent on the sensitivity of the camera chip.

The term “color value” as used herein is a broad term and is to be given its ordinary and customary meaning to a person of ordinary skill in the art and is not to be limited to a special or customized meaning. The term specifically may refer, without limitation, to a coordinate of an arbitrary color coordinate system used for describing a color using coordinates. Several color coordinate systems are generally known to the skilled person and may also be used in the context of this disclosure. Thus, as an example, a colorimetric coordinate system or a coordinate system may be used which is based on the human perception, such as the CIE 1964 color space, the Munsell color system or other coordinate systems, such as R, G, B or L, a, b.

For example, the color information of an object, such as of the optical test element, specifically of the test field of the optical test element, may be determined by a reflectance spectrum R of the object, the ambient light L, and the camera sensor characteristic S:

$$\int R ( λ ) * L ( λ ) * S ( λ ) d λ * gain = RGB .$$

Given that the reflectance spectrum of the object is known and the camera sensor characteristics is either known or at least constant per electronic measurement device, the “true” or “real” color of the object may be determined according to a spectral ambient light information, or at least an ambient light profile class.

The term “optical test element” as used herein is a broad term and is to be given its ordinary and customary meaning to a person of ordinary skill in the art and is not to be limited to a special or customized meaning. The term specifically may refer, without limitation, to an arbitrary element or device configured for performing an optical detection reaction, for example, a color-change detection reaction and/or a reaction during which one or more optically detectable features on or within the optical test element become visible, such as one or more markings, such as linear markings known from rapid COVID testing. The optical test element may, as an example, be embodied as a test strip or as a test stick. The optical test element may particularly have the at least one test field containing at least one test chemical being sensitive for the property of the sample, such as for detecting the at least one analyte. The optical test element may, as an example, comprise one or more application sites for applying the at least one sample. The application site may be different from the position of the test field and may be fluidically connected to the test field, such as by one or more capillary elements, such as one or more porous elements capable of transporting liquid. The optical test element, as an example, may comprise at least one substrate, such as at least one carrier, with the at least one test field applied thereto or integrated therein. The optical test element may comprise at least one control area, specifically in a proximity to the test field, for example, enclosing or surrounding the test field and/or arranged behind the test field in a direction of flow of the sample on the optical test element. The control area may be a separate field independently arranged on the substrate or carrier. The control area may be configured for indicating correct applying of the sample of the body fluid on the optical test element. The carrier, as an example, may be strip-shaped, thereby rendering the optical test element a test strip. These test strips are generally widely in use and available. One test strip may carry a single test field or a plurality of test fields having identical or different test chemicals comprised therein. Additionally or alternatively, the optical test element may be embodied as a stick or chip, e.g., with a housing having the above-mentioned substrate disposed therein, e.g., a housing having one or more application openings for applying the sample and one or more detection windows for enabling an optical detection of the at least one detection reaction. For example, the optical test element may be configured for performing at least one color-change detection reaction for detecting blood glucose in the sample of the body fluid, such as a blood glucose test. Alternatively or additionally, as another example, the optical test element may comprise at least one lateral flow assay, specifically at least one lateral flow assay configured for performing at least one reaction during which one or more optically detectable features on or within the optical test element become visible for detecting a presence of a virus in the sample of the body fluid, such as a rapid antigen test. Various further options may also be feasible.

The term “test field” as used herein is a broad term and is to be given its ordinary and customary meaning to a person of ordinary skill in the art and is not to be limited to a special or customized meaning. The term specifically may refer, without limitation, to a region of the optical test element having a coherent or contiguous amount of the test chemical, such as to a field, e.g., a field of round, polygonal or rectangular shape, having one or more layers of material, with at least one layer of the test field having the test chemical comprised therein. Other layers may be present providing specific optical properties such as reflective properties, providing spreading properties for spreading the sample or providing separation properties such as for separating of particulate components of the sample, such as cellular components. The sample of the body fluid may be applied directly to the test field, e.g., for blood glucose measurements where a droplet of blood may be directly applied to the optical test element comprising the test field, or may be applied indirectly to the test field, e.g., by applying the sample of the body fluid to a reservoir or an application site of the optical test element, wherein the sample of the body fluid may flow from the reservoir of application site to the test field of the optical test element, such as by capillary forces acting on the sample of the body fluid.

The set of lighting conditions may comprise a standard lighting condition and a plurality of further lighting conditions deviating from the standard lighting condition. The term “standard lighting condition” as used herein is a broad term and is to be given its ordinary and customary meaning to a person of ordinary skill in the art and is not to be limited to a special or customized meaning. The term specifically may refer, without limitation, to a lighting condition, from the set of lighting conditions as defined above, which is determined or predetermined to be the standard condition or reference condition. The further lighting conditions may be referenced to this standard lighting condition. Thus, as an example, the standard lighting condition may be the lighting condition which is given in most cases, during which the analytical method is performed. For example, the standard lighting condition may be the lighting condition in which the optical test elements are illuminated with cool white LED illumination.

As an example, the calibration functions of the calibration set may comprise a standard calibration function for the standard lighting condition and a plurality of further calibration functions for the further lighting conditions. The further calibration functions may comprise correction functions. The correction function may specifically describe deviation of the further calibration function for the further lighting condition from the standard calibration function for the standard lighting condition. For each of the further lighting conditions, the respective relationship between the item of optical information derived from the image captured with the camera from the at least one part of the test field of the optical test element under the respective further lighting condition and the concentration of the analyte in the sample applied to the test field may be determined by a combination of the standard calibration function and the correction function of the respective further lighting condition.

Alternatively or additionally, the calibration functions of the calibration set may comprise, for each lighting condition, a complete relationship between the item of optical information derived from the image captured with the camera from the at least one part of the test field of the optical test element under the respective lighting condition and the concentration of the analyte in the sample applied to the test field. The complete relationships for each lighting condition of the set of lighting conditions may specifically be independent from each other.

Step b. of the calibration method may further comprise:
b.1. providing a set of calibration samples having differing analyte concentrations, the analyte concentrations of the calibration samples being at least one of:
   known by calibration sample preparation;
   determinable by a standardized reference measurement;
b.2. providing a set of the optical test elements, each optical test element having the at least one test field being configured for changing at least one optically detectable property in the presence of the analyte;
b.3. applying each calibration sample to at least one optical test element of the set of optical test elements, such that a set of optical test elements having applied thereto samples with differing analyte concentrations is generated; and
b.4. determining the calibration functions by combining values of the at least one item of optical information derived from images captured with the camera from the at least one part of the test field of the optical test elements of the set of optical test elements of step b.3. with the respective analyte concentrations, the images being captured under the respective lighting conditions.

The method may specifically comprise performing steps b.1. to b.4. for each lighting condition of the set of lighting conditions.

The term “calibration sample” as used herein is a broad term and is to be given its ordinary and customary meaning to a person of ordinary skill in the art and is not to be limited to a special or customized meaning. The term specifically may refer, without limitation, to an arbitrary fluid having a known or predetermined concentration of the analyte. The calibration sample may be configured for emulating the properties of the sample of the body fluid with corresponding concentration of the analyte. Thus, the calibration sample, when applied to the optical test element, may be configured for causing the optical test element to perform the same optical detection reaction as the sample of the body fluid with equal analyte concentration, for example, a color-change detection reaction and/or a reaction during which one or more optically detectable features on or within the optical test element become visible, such as one or more markings. The calibration sample may be or may comprise a body fluid sample having a known or predetermined concentration of the analyte. As an example, the calibration sample may comprise venous blood, specifically venous blood with added analyte. Other examples, however, are also feasible.

The calibration method may further comprise:
c. determining at least one light sensor value of the ambient light sensor of the mobile device for each of the lighting conditions of the set of lighting conditions, and assigning the light sensor values to the respective calibration functions of the calibration set.

The term “light sensor value” as used herein is a broad term and is to be given its ordinary and customary meaning to a person of ordinary skill in the art and is not to be limited to a special or customized meaning. The term specifically may refer, without limitation, to an item of information qualifying and/or quantifying the ambient light, such as an item of information indicating an intensity of the ambient light. The light sensor value may specifically comprise at least one item of information on the ambient light for one or more wavelengths, specifically for a plurality of different wavelengths. The light sensor value may be specific for each lighting conditions of the set of lighting conditions. Thus, the light sensor value may be used for determining the respective lighting condition of the set of lighting condition, specifically in the analytical method, as will be outlined in further detail below.

In a further aspect of this disclosure, a computer-implemented analytical method of detecting at least one analyte in a sample of a body fluid by using a mobile device having at least one camera and at least one ambient light sensor is disclosed. The term “computer-implemented method” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the analytical method according to this disclosure. Preferably, each of the method steps may be performed by the computer and/or computer network. The computer-implemented analytical method may be performed completely automatically, specifically without user interaction.

Referring to the computer-implemented aspects of the analytical method, one or more of the method steps or even all of the method steps of the analytical method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual analytical measurement.

The analytical method comprises the following method steps, which specifically may be performed in the given order. However, a different order may also be possible. It is further possible to perform one, more than one or even all of the method steps repeatedly. Further, it is possible to perform two or more of the method steps in a fashion overlapping in time and/or fully or partially simultaneously.

The analytical method comprises:
i. retrieving image data of at least one image captured under at least one measurement lighting condition with the camera from at least one part of at least one test field of at least one optical test element having a sample of the body fluid applied thereto, the optical test element having at least one test field being configured for changing at least one optically detectable property in the presence of the analyte;
ii. obtaining at least one light sensor value of the ambient light sensor of the mobile device for the measurement lighting condition of step i, and assigning the measurement lighting condition to a lighting condition selected from a set of lighting conditions in accordance with the light sensor value;
iii. selecting, from a calibration set obtained by the calibration method according to this disclosure, such as according to any one of the embodiments disclosed above and/or according to any one of the embodiments disclosed in further detail below, a calibration function for the lighting condition of step ii.; and
iv. evaluating the image data of step i. by using the calibration function of step iii. to detect the analyte in the sample of the body fluid.

For definitions of terms and/or possible embodiments of terms and/or elements used in the analytical method, reference is made to the description of the calibration method above.

The term “retrieving” as used herein is a broad term and is to be given its ordinary and customary meaning to a person of ordinary skill in the art and is not to be limited to a special or customized meaning. The term specifically may refer, without limitation, to a process of a computer or computer network of generating and/or obtaining data from an arbitrary data source, such as from a data storage device, a computer system or a further computer or computer network. The retrieving specifically may take place via at least one interface, specifically via at least one interface of the mobile device. The retrieving may comprise several sub-steps, such as the sub-step of querying data, reading data, obtaining data and/or pre-processing data for further evaluation, such as by applying one or more algorithms to the obtained data, e.g., by using a processor of the mobile device. The retrieving of the image data may comprise directly obtaining the image data from the camera of the mobile device and/or indirectly obtaining the image data, e.g., via at least one data storage device storing the image data captured with the camera of the mobile device.

The term “image data” as used herein is a broad term and is, in line with the definition of the term “image” as outlined above, to be given its ordinary and customary meaning to a person of ordinary skill in the art and is not to be limited to a special or customized meaning. The term specifically may refer, without limitation, to at least a part of the data recorded by using the camera, such as a plurality of electronic readings from the imaging device, such as the pixels of the camera chip. Specifically, the image data may refer to a part of the data defining the image. For example, the image data may comprise at least one section of the image, e.g., a section of the test field of the optical test element. Alternatively or additionally, the image data may comprise at least one color channel of the image, e.g., a red color channel and/or a green color channel.

As an example, the retrieving in step i. may comprise capturing the at least one image, specifically capturing the image under the measurement lighting condition with the camera from the at least one part of the test field of the optical test element having the sample of the body fluid applied thereto, more specifically automatically capturing the image.

The term “measurement lighting condition” as used herein is a broad term and is to be given its ordinary and customary meaning to a person of ordinary skill in the art and is not to be limited to a special or customized meaning. The term specifically may refer, without limitation, to a lighting condition, specifically a lighting condition as defined above, being present during performing the analytical method. The measurement lighting condition may specifically refer to a lighting condition being present at a point in time when the image was captured with the camera of the mobile device.

The term “obtaining at least one light sensor value” as used herein is a broad term and is to be given its ordinary and customary meaning to a person of ordinary skill in the art and is not to be limited to a special or customized meaning. The term specifically may refer, without limitation, to a process of quantitatively or qualitatively determining at least one light sensor value using appropriate sensing means. Specifically, the light senor value may be obtained by quantitatively or qualitatively determining the at least one light sensor value using the ambient light sensor of the mobile device. The process of obtaining the light sensor value may be performed in a timely overlapping fashion with the capturing of the image of the at least one part of the optical test element having the sample of the body fluid applied to the test field, e.g., fully or partially simultaneously with the capturing of the image such that the light sensor value may be indicative of the measurement lighting condition at a point in time when the image is captured.

As outlined in detail above with respect to the calibration method, the ambient light sensor of the mobile device may comprise at least one of: a color sensor of the mobile device; a further camera of the mobile device, specifically a further camera being disposed on a side of the mobile device opposing the side of the camera used for capturing the images of step i.

The term “selecting” as used herein is a broad term and is to be given its ordinary and customary meaning to a person of ordinary skill in the art and is not to be limited to a special or customized meaning. The term specifically may refer, without limitation, to a process of choosing at least one item from a given or predetermined list of items. Specifically, the selecting of the calibration function may comprise choosing at least one calibration function, specifically exactly one calibration function, from the given or predetermined calibration set.

The calibration set of step iii. may be an empirically-determined calibration set. Specifically, the calibration set of step iii. may be determined by performing the calibration method according to this disclosure, such as according to any one of the embodiments disclosed above and/or according to any one of the embodiments disclosed in further detail below. Further, as outlined in detail above with respect to the calibration method, the calibration function of step iii. may be a scalar calibration function.

The term “evaluating” as used herein is a broad term and is to be given its ordinary and customary meaning to a person of ordinary skill in the art and is not to be limited to a special or customized meaning. The term specifically may refer, without limitation, to a process of processing data and deriving at least one representative result therefrom. Specifically, the evaluating may comprise processing the image data, e.g., one or more of a section of the image and/or at least one color value of the image, and deriving a concentration of the analyte in the sample of the body fluid therefrom. The evaluating may specifically comprise using the calibration function for processing the image data and/or deriving the concentration of the analyte in the sample of the body fluid therefrom.

The evaluating in step iv. may comprise deriving at least one item of optical information from the image data of step i. The item of optical information may comprise at least one of: a remission value; a color information, specifically a color information in one or more of a RGB color space, a L*a*b color space, a XYZ color space; a part of a color information, specifically one or more of a red color value and/or a green color value, more specifically a combination of a red color value and a green color value.

The evaluating in step iv. may comprise applying the selected calibration function of step iii. to the image data of step i.

As outlined above, the calibration set may comprise a standard calibration function for a standard lighting condition and a plurality of further calibration functions for further lighting conditions. The further calibration functions may comprise correction functions. The correction function may specifically describe deviation of the further calibration function for the further lighting condition from the standard calibration function for the standard lighting condition. For each of the further lighting conditions, the respective relationship between the item of optical information derived from the image captured with the camera from the at least one part of the at least one test field of the optical test element under the respective further lighting condition and the concentration of the analyte in the sample applied to the test field may be determined by a combination of the standard calibration function and the correction function of the respective further lighting condition. In this example, the selecting in step iii. may comprise selecting at least one correction function for the lighting condition of step ii. The evaluating in step iv. may comprise using the standard calibration function and the at least one correction function. For example, the standard calibration function and the at least one correction function may be combined into a corrected calibration function. The corrected calibration function may provide the relationship between the item of optical information derived from the image from the at least one part of the at least one test field of the optical test element under the measurement lighting condition of step ii, and a concentration of the analyte in the sample applied to the test field. The evaluating in step iv. may comprise applying the corrected calibration function to the image data of step i.

Alternatively or additionally, as outlined above, the calibration functions of the calibration set may comprise, for each lighting condition, a complete relationship between the item of optical information derived from the image captured with the camera from the at least one part of the test field of the optical test element under the respective lighting condition and the concentration of the analyte in the sample applied to the test field. The complete relationships for each lighting condition of the set of lighting conditions may specifically be independent from each other.

In a further aspect of this disclosure, a mobile device is disclosed, having at least one camera and at least one ambient light sensor, further having at least one processor, the processor being configured for performing the analytical method according to this disclosure, such as according to any one of the embodiments disclosed above and/or according to any one of the embodiments disclosed in further detail below.

For definitions of terms and/or possible embodiments of the analytical method, reference is made to the description of the analytical method and/or the calibration method above.

In a further aspect of this disclosure, a computer program is disclosed, comprising instructions which, when the program is executed by the processor of the mobile device according to this disclosure, such as according to any one of the embodiments disclosed above and/or according to any one of the embodiments disclosed in further detail below, cause the processor to perform the analytical method according to this disclosure, such as according to any one of the embodiments disclosed above and/or according to any one of the embodiments disclosed in further detail below.

The computer program may include computer-executable instructions for performing the analytical method according to this disclosure in one or more of the embodiments enclosed herein when the instructions are executed on a computer or computer network. Specifically, the computer program may be stored on a computer-readable data carrier and/or on a computer-readable storage medium.

Thus, specifically, one, more than one or even all of method steps i. to iv. as indicated above may be performed by using a computer or a computer network, preferably by using a computer program. Method steps requiring manual work, such as providing the samples and/or certain aspects of performing the actual analytical measurement, may be supported by the computer program, such as by prompting a user to perform the required steps, e.g., a sample application step.

Similarly, a computer-readable storage medium, specifically a non-transient computer readable storage medium, is disclosed, comprising instructions which, when the instructions are executed by the processor of the mobile device according to this disclosure, such as according to any one of the embodiments disclosed above and/or according to any one of the embodiments disclosed in further detail below, cause the processor to perform the analytical method according to this disclosure, such as according to any one of the embodiments disclosed above and/or according to any one of the embodiments disclosed in further detail below.

As used herein, the term “computer-readable storage medium” specifically may refer to non-transitory data storage means, such as a hardware storage medium having stored thereon computer-executable instructions. The computer-readable storage medium specifically may be or may comprise a storage medium such as a random-access memory (RAM) and/or a read-only memory (ROM).

The methods and devices according to this disclosure may provide a large number of advantages compared with known methods and devices. Specifically, the methods and devices according to this disclosure may be used for photo apps using a mobile device, such as a smartphone, in particular for home-testing, wherein one or more images of an optical test element, e.g., a blood glucose test or a lateral flow assay, such as rapid antigen tests, are captured by the using camera of the mobile device. From optically detectable changes within the test field, e.g., graphical elements like bars or color formation, the analyte can be detected, in particular the analyte concentration. The methods and devices according to this disclosure may allow performing the measurements even under unfavorable lighting conditions. The analytical method may comprise selecting one calibration function of previously determined calibration set, the calibration set specifically comprising a plurality of calibration functions being determined by using the calibration method, based on the light sensor value, e.g., based on an in-situ ambient light spectral composition obtained using the ambient light sensor of the mobile device, such as a second camera of the mobile device, e.g., a front camera. Using the calibration function may allow performing the analytical method in vast number of ambient lighting conditions since the set of calibration functions may provide calibration functions establishing a relationship between the item of optical information and the concentration of the analyte in the sample of the body fluid for any lighting condition of the set of lighting conditions. Furthermore, using calibration function for converting the item of optical information into the concentration of the analyte in the sample of the body fluid may consume much less computational power compared to a pixel-wise manipulation or correction and/or compared to general image manipulation or correction methods accounting for differences in the ambient light. Thus, the methods and devices according to this disclosure may allow for a more robust and user-friendly handling of analytical methods, specifically comprising photo app testing. The analytical method can be allowed even under unfavorable ambient lighting conditions. Without applying the calibration functions, the analytical method may only be allowed, e.g., if a known flashlight LED illumination of the mobile device outshines the ambient light. By applying the calibration functions selected for the respective lighting condition, the analytical method can be performed in any of the classified ambient lighting conditions.

A physical color of an object may be determined by a reflectance spectrum of the object, the ambient light and a camera sensor characteristic. Given that the reflectance spectrum of the object is known and the camera sensor characteristics is either known or at least constant per electronic measurement device, the color may be determined according to the spectral ambient light information, or at least an ambient light profile class. The methods and devices according to this disclosure may not limit measurements of the optical test element with the camera of the mobile device to situations where the ambient light is dominated by the known Flashlight LED illumination but instead allow measurements in any environment using the calibration function to account for the ambient light. The ambient light spectral composition may be obtained by the ambient light sensor of the mobile device and/or derived using a second camera, e.g., a front camera, of the mobile device.

The standard lighting condition, also referred to as reference lighting condition, and the corresponding standard calibration function for coding, i.e., linking the item of optical information to the quantitative analyte concentration value, may be known or predetermined. The ambient light may be determined and the corresponding correction function in combination with the standard calibration function may be applied to detect the analyte concentration value under the specific ambient lighting conditions. Alternatively, the calibration function corresponding to the specific ambient lighting conditions may be selected and may be directly applied to the item of optical information. The correction functions may be determined for a set of lighting conditions. For example, the set of lighting conditions may comprise eight different classified lighting conditions, such as daylight, incandescent light, fluorescent light, halogen, light, cool white LED illumination, warm white LED illumination, direct sun light and cloudy sky. The standard lighting condition may be cool white LED illumination. For all other light classes, the correction function may define a transformation function. In any case, the calibration function may provide means for evaluating the image data under any ambient light condition, which specifically may consume much less computational power compared to a pixel-wise and/or general image manipulation or correction method. The calibration method can be used in any analytical method comprising optical test diagnostic that is based on a generic camera data acquisition.

Summarizing and without excluding further possible embodiments, the following embodiments may be envisaged:

Embodiment 1: A calibration method for use in an analytical method of detecting at least one analyte in a sample of a body fluid by using a mobile device having at least one camera and at least one ambient light sensor, the calibration method comprising:
a. providing a set of lighting conditions; and
b. determining a calibration set, the calibration set comprising calibration functions for each of the lighting conditions of the set of lighting conditions, each calibration function providing a relationship between at least one item of optical information derived from at least one image captured with the camera from at least one part of at least one test field of an optical test element under the respective lighting condition and a concentration of the analyte in a sample applied to the test field.

Embodiment 2: The calibration method according to the preceding embodiment, further comprising:
c. determining at least one light sensor value of the ambient light sensor of the mobile device for each of the lighting conditions of the set of lighting conditions, and assigning the light sensor values to the respective calibration functions of the calibration set.

Embodiment 3: The calibration method according to any one of the preceding embodiments, wherein the set of lighting conditions comprises a standard lighting condition and a plurality of further lighting conditions deviating from the standard lighting condition.

Embodiment 4: The calibration method according to the preceding embodiment, wherein the calibration functions of the calibration set comprise a standard calibration function for the standard lighting condition and a plurality of further calibration functions for the further lighting conditions.

Embodiment 5: The calibration method according to the preceding embodiment, wherein the further calibration functions comprise correction functions, wherein, for each of the further lighting conditions, the respective relationship between the item of optical information derived from the image captured with the camera from the at least one part of the at least one test field of the optical test element under the respective further lighting condition and the concentration of the analyte in the sample applied to the test field is determined by a combination of the standard calibration function and the correction function of the respective further lighting condition.

Embodiment 6: The calibration method according to any one of the preceding embodiments, wherein step b. comprises:
b.1. providing a set of calibration samples having differing analyte concentrations, the analyte concentrations of the calibration samples being at least one of:
   known by calibration sample preparation;
   determinable by a standardized reference measurement;
b.2. providing a set of the optical test elements, each optical test element having the at least one test field being configured for changing at least one optically detectable property in the presence of the analyte;
b.3. applying each calibration sample to at least one optical test element of the set of optical test elements, such that a set of optical test elements having applied thereto samples with differing analyte concentrations is generated; and
b.4. determining the calibration functions by combining values of the at least one item of optical information derived from images captured with the camera from the at least one part of the test field of the optical test elements of the set of optical test elements of step b.3. with the respective analyte concentrations, the images being captured under the respective lighting conditions.

Embodiment 7: The calibration method according to any one of the preceding embodiments, wherein step b. comprises generating the calibration set as a set of computer-readable data.

Embodiment 8: The calibration method according to any one of the preceding embodiments, wherein the calibration function, and optionally the correction function, are scalar calibration functions.

Embodiment 9: The calibration method according to any one of the preceding embodiments, wherein the item of optical information comprises at least one of: a remission value; a color information, specifically a color information in one or more of a RGB color space, a L*a*b color space, a XYZ color space; a part of a color information, specifically one or more of a red color value and/or a green color value, more specifically a combination of a red color value and a green color value.

Embodiment 10: The calibration method according to any one of the preceding embodiments, wherein the ambient light sensor of the mobile device comprises at least one of: a color sensor of the mobile device; a further camera of the mobile device, specifically a further camera being disposed on a side of the mobile device opposing the side of the camera used for capturing the images in step b.

Embodiment 11: A computer-implemented analytical method of detecting at least one analyte in a sample of a body fluid by using a mobile device having at least one camera and at least one ambient light sensor, the analytical method comprising:
i. retrieving image data of at least one image captured under at least one measurement lighting condition with the camera from at least one part of at least one test field of at least one optical test element having a sample of the body fluid applied thereto, the optical test element having at least one test field being configured for changing at least one optically detectable property in the presence of the analyte;
ii. obtaining at least one light sensor value of the ambient light sensor of the mobile device for the measurement lighting condition of step i, and assigning the measurement lighting condition to a lighting condition selected from a set of lighting conditions in accordance with the light sensor value;
iii. selecting, from a calibration set obtained by the calibration method according to any one of the preceding embodiments, a calibration function for the lighting condition of step ii.; and
iv. evaluating the image data of step i. by using the calibration function of step iii. to detect the analyte in the sample of the body fluid.

Embodiment 12: The analytical method according to the preceding embodiment, wherein the calibration set of step iii. is an empirically-determined calibration set.

Embodiment 13: The analytical method according to any one of the preceding embodiments referring to an analytical method, wherein the calibration function of step iii. is a scalar calibration function.

Embodiment 14: The analytical method according to any one of the preceding embodiments referring to an analytical method, wherein the evaluating in step iv. comprises deriving at least one item of optical information from the image data of step i.

Embodiment 15: The analytical method according to the preceding embodiment, wherein the item of optical information comprises at least one of: a remission value; a color information, specifically a color information in one or more of a RGB color space, a L*a*b color space, a XYZ color space; a part of a color information, specifically one or more of a red color value and/or a green color value, more specifically a combination of a red color value and a green color value.

Embodiment 16: The analytical method according to any one of the preceding embodiments referring to an analytical method, wherein the evaluating in step iv. comprises applying the selected calibration function of step iii. to the image data of step i.

Embodiment 17: The analytical method according to any one of the preceding embodiments referring to an analytical method, wherein the calibration set comprises a standard calibration function for a standard lighting condition and a plurality of further calibration functions for further lighting conditions, wherein the further calibration functions comprise correction functions.

Embodiment 18: The analytical method according to the preceding embodiment, wherein for each of the further lighting conditions, the respective relationship between the item of optical information derived from the image captured with the camera from the at least one part of the at least one test field of the optical test element under the respective further lighting condition and the concentration of the analyte in the sample applied to the test field is determined by a combination of the standard calibration function and the correction function of the respective further lighting condition.

Embodiment 19: The analytical method according to any one of the two preceding embodiments, wherein the selecting in step iii. comprises selecting at least one correction function for the lighting condition of step ii.

Embodiment 20: The analytical method according to the preceding embodiment, wherein the evaluating in step iv. comprises using the standard calibration function and the at least one correction function.

Embodiment 21: The analytical method according to the preceding embodiment, wherein the standard calibration function and the at least one correction function are combined into a corrected calibration function, the corrected calibration function providing the relationship between the item of optical information derived from the image from the at least one part of the at least one test field of the optical test element under the measurement lighting condition of step ii, and a concentration of the analyte in the sample applied to the test field.

Embodiment 22: The analytical method according to the preceding embodiment, wherein the evaluating in step iv. comprises applying the corrected calibration function to the image data of step i.

Embodiment 23: The analytical method according to any one of the preceding embodiments referring to an analytical method, wherein the ambient light sensor of the mobile device comprises at least one of: a color sensor of the mobile device; a further camera of the mobile device, specifically a further camera being disposed on a side of the mobile device opposing the side of the camera used for capturing the images of step i.

Embodiment 24: The analytical method according to any one of the preceding embodiments referring to an analytical method, wherein the retrieving in step i. comprises capturing the at least one image.

Embodiment 25: A mobile device having at least one camera and at least one ambient light sensor, further having at least one processor, the processor being configured for performing the analytical method according to any one of the preceding embodiments referring to an analytical method.

Embodiment 26: A computer program comprising instructions which, when the program is executed by the processor of the mobile device according to the preceding embodiment, cause the processor to perform the analytical method according to any one of the preceding embodiments referring to an analytical method.

Embodiment 27: A computer-readable storage medium, specifically a non-transient computer readable storage medium, comprising instructions which, when the instructions are executed by the processor of the mobile device according to the preceding embodiment referring to a mobile device, cause the processor to perform the analytical method according to any one of the preceding embodiments referring to an analytical method.

### BRIEF DESCRIPTION OF THE DRAWINGS

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of this disclosure is not restricted by the preferred embodiments. The embodiments are schematically depicted in the Figures. Therein, identical reference numbers in these Figures refer to identical or functionally comparable elements.

The above-mentioned aspects of exemplary embodiments will become more apparent and will be better understood by reference to the following description of the embodiments taken in conjunction with the accompanying drawings, wherein:

FIG. 1 shows an embodiment of a mobile device in a schematic view;

FIG. 2 a flow chart of an embodiment of calibration method;

FIG. 3A to 3H show an exemplary set of lighting conditions; and

FIG. 4 shows a flow chart of an embodiment of a computer-implemented analytical method.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

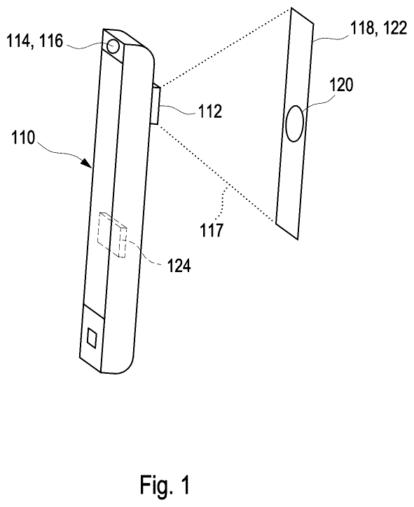

FIG. 1 shows an exemplary embodiment of a mobile device 110 according to this disclosure in a schematic view. The mobile device 110 has at least one camera 112 and at least one ambient light sensor 114. In the exemplary embodiment of FIG. 1, the ambient light sensor 114 may comprise a further camera 116 of the mobile device 110, specifically a further camera 116 being disposed on a side of the mobile device 110 opposing the side of the camera 112 used for capturing images, such as the images in step b. of the calibration method and/or the images in step i. of the analytical method, as will be outlined in further detail below. However, other ambient light sensors 114, such as a color sensor of the mobile device 110 may also be feasible.

As shown in FIG. 1, the camera 112 of the mobile device 110 may have a field of view 117 for capturing images of at least a part of an optical test element 118 having at least one test field 120 being configured for changing at least one optically detectable property in the presence of the analyte. In the example of FIG. 1, the optical test element 118 may comprise a blood glucose test 122 and, thus, may be configured for performing at least one color-change detection reaction for detecting blood glucose in the sample of the body fluid. However, other options, such as a lateral flow assay, e.g., a rapid antigen test, may also be feasible.

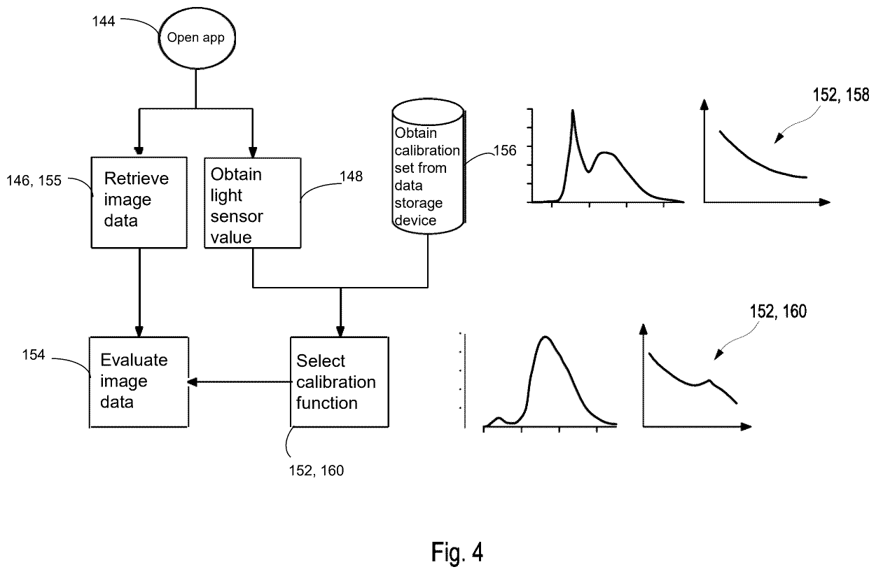

The mobile device 110 further has at least one processor 124. The processor 124 is configured for performing the analytical method according to this disclosure, such as according to any one of the embodiments disclosed above and/or according to the exemplary embodiment described with respect to FIG. 4. Thus, for a detailed description of the analytical method performed by the mobile device 110, reference is made to the description of FIG. 4.

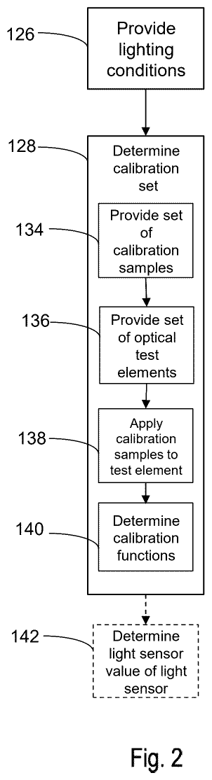

FIG. 2 shows a flow chart of an embodiment of calibration method according to this disclosure, for use in an analytical method, such as in the analytic method described with respect to FIG. 4. The analytical method is an analytical method of detecting at least one analyte in a sample of a body fluid by using a mobile device 110 having at least one camera 112 and at least one ambient light sensor 114. In the calibration method and in the analytical method, one and the same mobile device 110 may be used, e.g., the exemplary embodiment of the mobile device 110 shown in FIG. 1. Alternatively, however, different mobile devices 110 may be used, such as mobile devices 110 of the same or similar type. Thus, as an example, the calibration method may be performed with a prototypical mobile device 110 representing a group of mobile devices 110 with which the analytical method may then be performed, using the results of the calibration method.

The calibration method comprises the following method steps, which specifically may be performed in the given order. However, a different order may also be possible. It is further possible to perform one, more than one or even all of the method steps repeatedly. Further, it is possible to perform two or more of the method steps in a fashion overlapping in time and/or fully or partially simultaneously.

The calibration method comprises:
a. (denoted by reference number 126) providing a set of lighting conditions; and
b. (denoted by reference number 128) determining a calibration set, the calibration set comprising calibration functions for each of the lighting conditions of the set of lighting conditions, each calibration function providing a relationship between at least one item of optical information derived from at least one image captured with the camera 112 from at least one part of the at least one test field 120 of the optical test element 118 under the respective lighting condition and a concentration of the analyte in a sample applied to the test field 120.

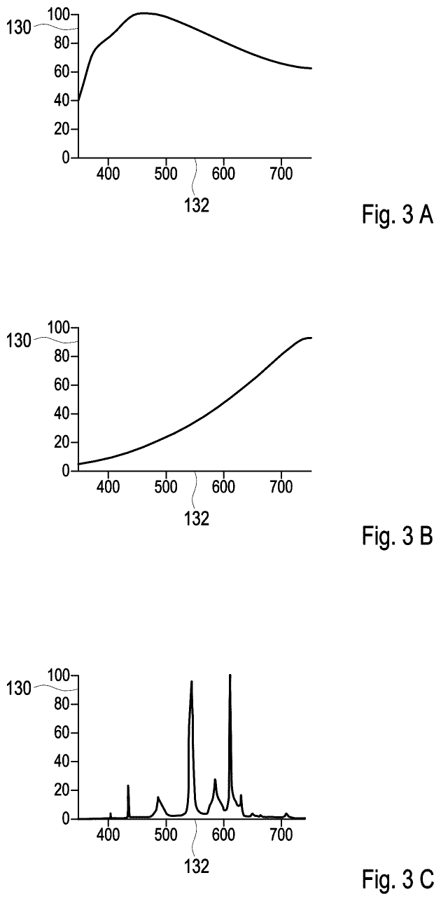

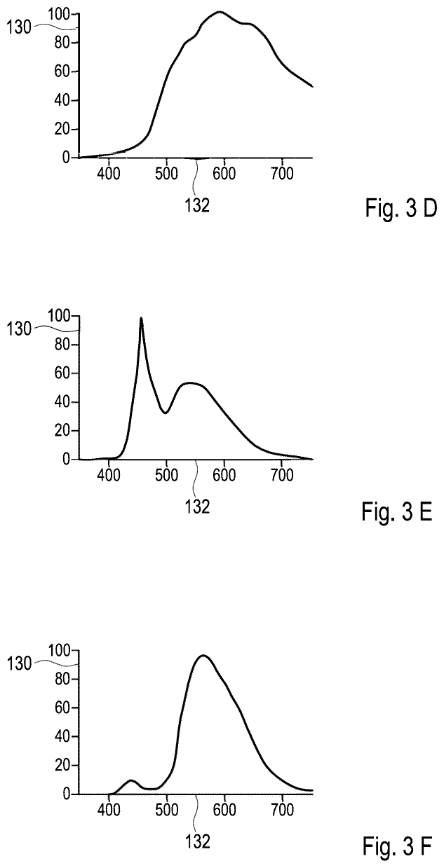

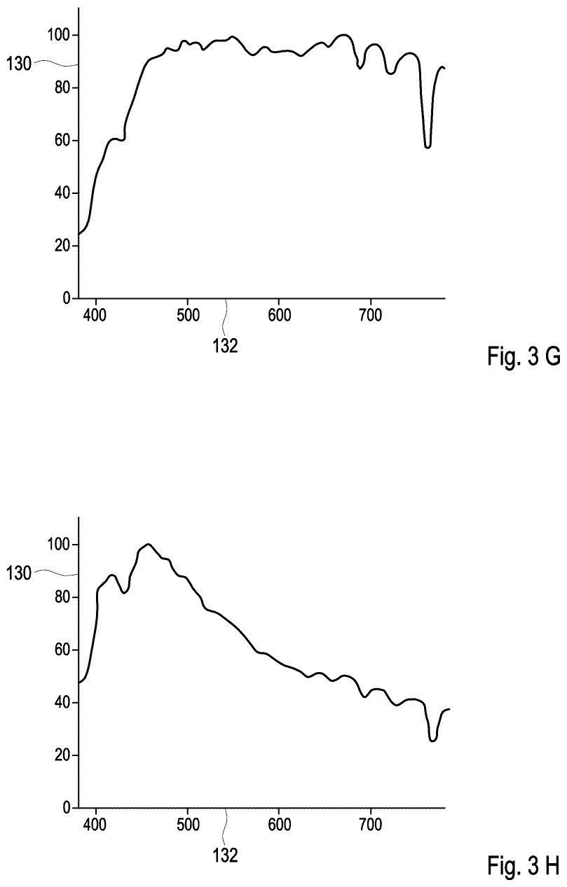

The set of lighting conditions, as an example, may comprise different classes of lighting conditions. An exemplary set of lighting conditions is shown in FIGS. 3A to 3H. Specifically, FIGS. 3A to 3H show diagrams of an intensity of ambient light 130 in a.u. as a function of wavelength 132. FIG. 3A shows the intensity of ambient light 130 for daylight. As can be seen in FIG. 3A, daylight typically has a rather broad and even spectral composition over the visible spectral range. FIG. 3B shows the intensity of ambient light 130 for incandescent light. As can be seen in FIG. 3B, incandescent light typically has an increasing intensity towards the infrared end of the visible spectral range. FIG. 3C shows the intensity of ambient light 130 for fluorescent light. As can be seen in FIG. 3C, fluorescent light typically has a plurality of single spectral peaks in the visible spectral range. FIG. 3D shows the intensity of ambient light 130 for halogen light. As can be seen in FIG. 3D, halogen light typically has a rather broad spectral peak, e.g., in the yellow or red spectral range. FIG. 3E shows the intensity of ambient light 130 for cool white LED illumination. As can be seen in FIG. 3E, cool white LED illumination typically has a single peak in the blue spectral range and a rather broad spectral peak in the green spectral range, specifically having a smaller intensity than the single peak in the blue spectral range. FIG. 3F shows the intensity of ambient light 130 for warm white LED illumination. As can be seen in FIG. 3F, warm white LED illumination typically has a rather broad spectral peak in the green spectral range, wherein the single peak in the blue spectral range is reduced compared to the intensity of the single peak in the blue spectral range of cool white LED illumination. FIG. 3G shows the intensity of ambient light 130 for direct sun light. As can be seen in FIG. 3G, direct sun light typically shows a plateau over the visible spectral range with pronounced spectral lines in the red spectral range. FIG. 3H shows the intensity of ambient light 130 for a cloudy sky. As can be seen in FIG. 3H, the ambient light for a cloudy sky typically shows a decreasing intensity of ambient light from the blue spectral range to the red spectral range. Thus, in this example, the set of lighting conditions may comprise eight different classes of lighting conditions. However, other examples are also feasible in addition or as an alternative.

In this example, the calibration functions of the calibration set may comprise a standard calibration function for the standard lighting condition and a plurality of further calibration functions for the further lighting conditions. The standard lighting condition may be cool white LED illumination shown in FIG. 3E. The further calibration functions may comprise correction functions. The correction function may specifically describe deviation of the further calibration function for the further lighting condition from the standard calibration function for the standard lighting condition. For each of the further lighting conditions, the respective relationship between the item of optical information derived from the image captured with the camera 112 from the at least one part of the test field 120 of the optical test element 118 under the respective further lighting condition and the concentration of the analyte in the sample applied to the test field 120 may be determined by a combination of the standard calibration function and the correction function of the respective further lighting condition. Alternatively or additionally, other calibration functions, such as calibration functions with a complete relationship between the item of optical information and the concentration of the analyte in the sample, are also feasible.

Turning back to FIG. 2, step b. of the calibration method may further comprise:
b.1. (denoted by reference number 134) providing a set of calibration samples having differing analyte concentrations, the analyte concentrations of the calibration samples being at least one of:
   known by calibration sample preparation;
   determinable by a standardized reference measurement;
b.2. (denoted by reference number 136) providing a set of the optical test elements 118, each optical test element 118 having the at least one test field 120 being configured for changing at least one optically detectable property in the presence of the analyte;
b.3. (denoted by reference number 138) applying each calibration sample to at least one optical test element 118 of the set of optical test elements 118, such that a set of optical test elements 118 having applied thereto samples with differing analyte concentrations is generated; and
b.4. (denoted by reference number 140) determining the calibration functions by combining values of the at least one item of optical information derived from images captured with the camera 112 from the at least one part of the test field 120 of the optical test elements 118 of the set of optical test elements 118 of step b.3. with the respective analyte concentrations, the images being captured under the respective lighting conditions.

The method may specifically comprise performing steps b.1. to b.4. for each lighting condition of the set of lighting conditions, e.g., for each of the lighting conditions shown in FIGS. 3A to 3H.

The method, optionally, may further comprise:
c. (denoted by reference number 142) determining at least one light sensor value of the ambient light sensor 114 of the mobile device 110 for each of the lighting conditions of the set of lighting conditions, and assigning the light sensor values to the respective calibration functions of the calibration set.

As will be outlined in further detail below, the light sensor value obtained by the ambient light sensor 114 of the mobile device 110 may be indicative of the respective lighting conditions and, thus, calibrations functions may be selected in a subsequent analytical method according to the lighting conditions and the light sensor value.

FIG. 4 shows a flow chart of an embodiment of a computer-implemented analytical method of detecting at least one analyte in a sample of a body fluid by using a mobile device 110 having at least one camera 112 and at least one ambient light sensor 114. The analytical method may specifically comprise using the exemplary embodiment of a mobile device 110 shown in FIG. 1. However, other embodiments of the mobile device 110 are also feasible.

The analytical method comprises the following method steps, which specifically may be performed in the given order. However, a different order may also be possible. It is further possible to perform one, more than one or even all of the method steps repeatedly. Further, it is possible to perform two or more of the method steps in a fashion overlapping in time and/or fully or partially simultaneously.

The analytical method may be started by a user, e.g., by a user opening an application on the mobile device 110 (denoted by reference number 144).

The analytical method comprises:
i. (denoted by reference number 146) retrieving image data of at least one image captured under at least one measurement lighting condition with the camera 112 from at least one part of the at least one test field 120 of the at least one optical test element 118 having a sample of the body fluid applied thereto, the optical test element 118 having the at least one test field 120 being configured for changing at least one optically detectable property in the presence of the analyte;
ii. (denoted by reference number 148) obtaining at least one light sensor value of the ambient light sensor 114 of the mobile device 110 for the measurement lighting condition of step i, and assigning the measurement lighting condition to a lighting condition selected from a set of lighting conditions in accordance with the light sensor value;
iii. (denoted by reference number 150) selecting, from a calibration set obtained by the calibration method according to this disclosure, such as according to the exemplary embodiment described with respect to FIG. 2 and/or according to any other embodiment disclosed herein, a calibration function 152 for the lighting condition of step ii.; and
iv. (denoted by reference number 154) evaluating the image data of step i. by using the calibration function 152 of step iii. to detect the analyte in the sample of the body fluid.

In the exemplary embodiment of FIG. 4, the retrieving in step i. may comprise capturing the at least one image, specifically capturing the image under the measurement lighting condition with the camera 112 from the at least one part of the test field 120 of the optical test element 118 having the sample of the body fluid applied thereto, more specifically automatically capturing the image (denoted by reference number 155).

The calibration set of step iii. may be an empirically-determined calibration set. Specifically, the calibration set of step iii. may be determined by performing the calibration method according to this disclosure, such as according to the embodiment described with respect to FIG. 2 and/or according to any other embodiment disclosed herein. Further, as outlined in detail above with respect to the calibration method and as can be seen in FIG. 4, the calibration function 152 of step iii. may be a scalar calibration function. As indicated by reference number 156 in FIG. 4, the calibration set in step iii. may be obtained from a data storage device, such as a data storage device of the mobile device 110 or a cloud-based data storage device.

As outlined above, the calibration set may comprise a standard calibration function 158 for a standard lighting condition and a plurality of further calibration functions 160 for further lighting conditions. Here again, as an example, the standard lighting condition may be cool white LED illumination. The further calibration functions 160 may comprise correction functions. The correction function may specifically describe deviation of the further calibration function 160 for the further lighting condition from the standard calibration function 158 for the standard lighting condition. For each of the further lighting conditions, the respective relationship between the item of optical information derived from the image captured with the camera 112 from the at least one part of the at least one test field 120 of the optical test element 118 under the respective further lighting condition and the concentration of the analyte in the sample applied to the test field 120 may be determined by a combination of the standard calibration function 158 and the correction function of the respective further lighting condition. In this example, the selecting in step iii. may comprise selecting at least one correction function for the lighting condition of step ii. The evaluating in step iv. may comprise using the standard calibration function 158 and the at least one correction function. For example, the standard calibration function 158 and the at least one correction function may be combined into a corrected calibration function (denoted by reference number 162). The step 162 may specifically be an optional method step. E.g., in case the calibration functions 152 of the calibration set may comprise a complete relationship for each lighting condition of the set of lighting conditions, the method step of combining the standard calibration function 158 and the correction function can be omitted. The corrected calibration function may provide the relationship between the item of optical information derived from the image from the at least one part of the at least one test field 120 of the optical test element 118 under the measurement lighting condition of step ii, and a concentration of the analyte in the sample applied to the test field 120. The evaluating in step iv. may comprise applying the corrected calibration function to the image data of step i.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE NUMBERS

110 mobile device
112 camera
114 ambient light sensor
116 further camera
117 field of view
118 optical test element
120 test field
122 blood glucose test
124 processor
126 providing a set of lighting conditions
128 determining a calibration set
130 intensity of ambient light
132 wavelength
134 providing a set of calibration samples
136 providing a set of the optical test elements
138 applying each calibration sample to an optical test element
140 determining the calibration functions
142 determining a light sensor value
144 start
146 retrieving image data
148 obtaining at least one light sensor value
150 selecting a calibration function
152 calibration function
154 evaluating the image data
155 capturing an image
156 obtaining a calibration set from a data storage device
158 standard calibration function
160 further calibration function
162 combining standard calibration function and correction function

What is claimed is:

1. A calibration method for use in an analytical method of detecting an analyte in a sample of a body fluid using a mobile device having a camera and an ambient light sensor that is fully distinct from the camera, the calibration method comprising:
a. providing a set of lighting conditions;
b. determining a calibration set comprising calibration functions for each of the lighting conditions of the set of lighting conditions, each calibration function providing a relationship between an item of optical information derived from an image captured with the camera from at least one part of a test field of an optical test element under the respective lighting condition and a concentration of the analyte in a sample applied to the test field; and
c. obtaining a light sensor value by the ambient light sensor for each of the lighting conditions of the set of lighting conditions, and assigning the light sensor values to the respective calibration functions of the calibration set.

2. The calibration method according to claim 1, wherein the set of lighting conditions comprises a standard lighting condition and a plurality of further lighting conditions deviating from the standard lighting condition, wherein the calibration functions comprise a standard calibration function for the standard lighting condition and a plurality of further calibration functions for the further lighting conditions.

3. The calibration method according to claim 2, wherein the further calibration functions comprise correction functions, wherein, for each of the further lighting conditions, the respective relationship between the item of optical information derived from the image captured with the camera from the test field under the respective further lighting condition and the concentration of the analyte in the sample applied to the test field is determined by a combination of the standard calibration function and the correction function of the respective further lighting condition.

4. The calibration method according to claim 1, wherein step b. comprises:
b.1. providing a set of calibration samples having differing analyte concentrations, the analyte concentrations of the calibration samples being at least one of:
known by calibration sample preparation;
determinable by a standardized reference measurement;
b.2. providing a set of the optical test elements, each optical test element having the a test field configured for changing an optically detectable property in the presence of the analyte;
b.3. applying each calibration sample to at least one optical test element of the set of optical test elements, whereby a set of optical test elements having samples applied thereto with differing analyte concentrations is generated; and
b.4. determining the calibration functions by combining values of the at least one item of optical information derived from images captured with the camera from the at least one part of the test field of the optical test elements of the set of optical test elements of step b.3. with the respective analyte concentrations, the images being captured under the respective lighting conditions.

5. The calibration method according to claim 1, wherein the item of optical information comprises at least one of: a remission value; a color information; a part of a color information.

6. The calibration method according to claim 1, wherein the ambient light sensor comprises at least one of: a color sensor; a further camera.

7. A computer-implemented analytical method of detecting an analyte in a sample of a body fluid using a mobile device having a camera and an ambient light sensor that is fully distinct from the camera, the method comprising:
i. retrieving image data of an image captured under a measurement lighting condition with the camera from at least one part of a test field of an optical test element having a sample of the body fluid applied thereto, the optical test element having a test field configured for changing an optically detectable property in the presence of the analyte;
ii. obtaining a light sensor value of the ambient light sensor for the measurement lighting condition of step i, and assigning the measurement lighting condition to a lighting condition selected from a set of lighting conditions in accordance with the light sensor value;
iii. selecting, from a calibration set obtained by the calibration method according to claim 1, a calibration function for the lighting condition of step ii.; and
iv. evaluating the image data of step i. by using the calibration function of step iii. to detect the analyte in the sample of the body fluid.

8. The analytical method according to claim 7, wherein the evaluating in step iv. comprises deriving an item of optical information from the image data of step i., wherein the item of optical information comprises at least one of a remission value, a color information, a part of a color information.

9. The analytical method according to claim 7, wherein step iv. comprises applying the selected calibration function of step iii. to the image data of step i.

10. The analytical method according to claim 7, wherein:
the calibration set comprises a standard calibration function for a standard lighting condition and a plurality of further calibration functions for further lighting conditions, wherein the further calibration functions comprise correction functions;
the selecting in step iii. comprises selecting at least one correction function for the lighting condition of step ii.;
the evaluating in step iv. comprises using the standard calibration function and the at least one correction function, wherein the standard calibration function and the at least one correction function are combined into a corrected calibration function providing the relationship between the item of optical information derived from the image from the test field under the measurement lighting condition of step ii, and a concentration of the analyte in the sample applied to the test field; and
the evaluating in step iv. comprises applying the corrected calibration function to the image data of step i.

11. The analytical method according to claim 7, wherein the ambient light sensor comprises at least one of: a color sensor of the mobile device; a further camera of the mobile device.

12. A mobile device, comprising:
a camera;
an ambient light sensor;
a processor configured for performing the analytical method according to claim 7.

13. A computer program comprising instructions which, when the program is executed by the processor of the mobile device according to the preceding claim, causes the processor to perform the analytical method according to claim 7.

14. A computer-readable storage medium, comprising instructions which, when the instructions are executed by the processor of a mobile device, causes the processor to perform the analytical method according to claim 7.
